(19) United States
(12) Patent Application Publication
(10) Pub. No.: US 2026/0087772 A1
(43) Pub. Date: Mar. 26, 2026

(54) METHODS AND SYSTEMS FOR GENERATING THREE-DIMENSIONAL REPRESENTATIONS

(71) Applicant: Telefonaktiebolaget LM Ericsson (publ), Stockholm (SE)

(72) Inventors: Elijs DIMA, Stockholm (SE); Volodya GRANCHAROV, Stockholm (SE); Sigurdur SVERRISSON, Stockholm (SE); André MATEUS, Stockholm (SE)

(73) Assignee: Telefonaktiebolaget LM Ericsson (publ), Stockholm (SE)

(21) Appl. No.: 19/112,615

(22) PCT Filed: Sep. 21, 2022
(86) PCT No.: PCT/SE2022/050829

§ 371 Date: Mar. 18, 2025

(51) Int. Cl. G06V 10/75; G06V 10/26; G06V 10/77

(52) U.S. Cl. CPC G06V 10/757; G06V 10/26; G06V 10/7715

(57) ABSTRACT

A method for processing images. The method includes obtaining a first image and a second image. The method also includes dividing the first image into N regions. The method also includes, for a first region of the first image, defining a corresponding first region of the second image, and, for a second region of the first image, defining a corresponding second region of the second image. The method also includes detecting a first feature in the first region of the first image and detecting a second feature in the second region of the first image. The method also includes searching the second image for a feature matching the first feature, wherein the searching of the second image for the feature matching the first feature is limited to searching only the corresponding first region of the second image. The method further includes searching the second image for a feature matching the second feature, wherein the searching of the second image for a feature matching the second feature is limited to searching only the corresponding second region of the second image.

### TECHNICAL FIELD

Disclosed are embodiments related to generating three-dimensional (3D) representations of a scene (e.g., a room, an object, etc.).

### BACKGROUND

In many industrial applications it is important to generate a three-dimensional (3D) point cloud representing a scene (e.g., a floor of a factory). A 3D point cloud is typically generated using the following scanning process: a technician sets-up a scanning device (e.g., 360-degree camera) on a tripod, places the tripod at different locations on the floor, and captures the scene from all these locations. Then the sensory inputs (e.g., images) from the scan at each location are stitched together.

Image feature matching (often called “key point matching”) is a common technique that is used to construct 3D geometry of a scene from set of 2D images. Referring to FIG. 8, after a key point 802 (e.g., a chair) in a first image 811 is matched with the corresponding key point 804 (i.e., the same chair) in a second image 8112, the depth in the scene is estimated by means of triangulation, as shown in FIG. 8. As illustrated in FIG. 8, 3D geometry of a scene is reconstructed by stitching different shots and performing triangulation. The Black circles in FIG. 8 are the camera positions, the black squares are key points, common for both images (e.g., same object in the physical scene). The dashed circle is the 3D point of the sparse point cloud, obtained by triangulation.

### 360-Degree Cameras and Equirectangular Images

A 360-degree camera is a camera that can shoot in all directions: up, down, left, right, front and back. Typically, a 360-degree camera is equipped with two wide-angle lenses with a field of view over 180 degrees. The camera takes a photo through each lens at the same time. The borders of the images captured by each lens are stitched together to generate a 360-degree photograph (or video). Modern optics and image processing allow high-precision and high-speed image stitching resulting in joints that are almost invisible. There are other methods of taking 360-degree images such as using cameras with 3 or more lenses as well as shooting with a conventional digital camera and then synthesizing 360-degree images using software.

Images taken with conventional digital cameras (e.g., a smartphone camera) are generally saved as rectangular images with aspect ratios of 3:2, 4:3, or 16:9. 360-degree cameras convert a spherical image into an omnidirectional planar image. This format is called “equirectangular.”

As noted above, identifying features (a.k.a. key points) between two or more camera images is a common task in computer vision, with many feature detection and matching algorithms that are widely used in 3D reconstruction tools. But a problem with these conventional key point matching techniques and 3D reconstruction solutions is that they are not designed for equirectangular images, and therefore tend to have excessively many “incorrect” matches. This is due to the increased field of view of equirectangular images and the larger differences between the image features across different shots. Moreover, the existing solutions do not make use of the inherent properties of vertically-aligned equirectangular images to constrain or parallelize the feature search in an efficient way.

There have been attempts to solve this problem. An example is presented in Cruz-Mota, J., et al., 2012, “Scale invariant feature transform on the sphere: Theory and applications,” International journal of computer vision, 98(2), pp. 217-241 (hereafter “reference [1]”), which proposes an adaptation of the scale invariant feature transform (SIFT) features to the spherical camera model. The method is based on spectral analysis of spherical panoramic images.

Another example is presented in Zhao, Q., et al., 2015, “SPHORB: A fast and robust binary feature on the sphere,” International journal of computer vision, 113(2), pp. 143-159 (hereafter “reference [2]”). In reference [2], an extension of ORB features to work on the spherical images is proposed. It is based on creating a hexagonal grid on the unit sphere. A similar approach to extend BRISK features is presented in Guan, H., 2017, “BRISKS: Binary features for spherical images on a geodesic grid,” In Proceedings of the IEEE Conference on Computer Vision and Pattern Recognition (pp. 4516-4524) (hereafter “reference [3]”).

Yet another example is presented in Kang, D., Jang, H., Lee, J., Kyung, C. M. and Kim, M. H., 2022. Uniform Subdivision of Omnidirectional Camera Space for Efficient Spherical Stereo Matching. In Proceedings of the IEEE/CVF Conference on Computer Vision and Pattern Recognition (pp. 12972-12980). (hereafter “reference [4]”). In reference [4], a method for matching across a stereo pair of omnidirectional images is proposed.

### SUMMARY

Certain challenges presently exist. For instance, with respect to the technique disclosed in reference [1] there is a limitation in the bandwidth and a high computational requirement of spherical harmonics. With respect to references [2] and [3], the solutions disclosed therein lead to a piecewise planar approximation of the sphere that introduces additional distortion. Lastly, with respect to [4], the matching is guided by epipolar lines (curves in the sphere and/or equirectangular image) and this requires the pose between the two images to be known a priori.

Accordingly, in one aspect there is provided an improved method for processing images. The method includes obtaining a first image and obtaining a second image. The method also includes logically dividing the first image into N regions, where N≥2 such that the set of N regions comprises a first region of the first image and a second region of the first image, wherein the first region of the first image does not include the entire first image, the second region of the first image does not include the entire first image, and the first region of the first image and the second region of the first image do not overlap. The method also includes, for the first region of the first image, defining a corresponding first region of the second image, wherein the corresponding first region of the second image does not include the entire second image. The method also includes, for the second region of the first image, defining a corresponding second region of the second image, wherein the corresponding second region of the second image does not include the entire second image. The method also includes detecting a first feature in the first region of the first image and detecting a second feature in the second region of the first image. The method also includes searching the second image for a feature matching the first feature detected in the first region of the first image, wherein the searching of the second image for a feature matching the first feature detected in the first region of the first image is limited to searching only the corresponding first region of the second image for a feature matching the first feature. The method further includes searching the second image for a feature matching the second feature detected in the second region of the first image, wherein the searching of the second image for a feature matching the second feature detected in the second region of the first image is limited to searching only the corresponding second region of the second image for a feature matching the second feature.

In another aspect there is provided a computer program comprising instructions which when executed by processing circuitry of an image processing apparatus causes the apparatus to perform any of the methods disclosed herein. In one embodiment, there is provided a carrier containing the computer program wherein the carrier is one of an electronic signal, an optical signal, a radio signal, and a computer readable storage medium. In another aspect there is provided an image processing apparatus that is configured to perform the methods disclosed herein. The image processing apparatus may include memory and processing circuitry coupled to the memory.

An advantage of the embodiments disclosed herein is that a smaller amount of features needs to be considered for each matching step (and overall, less comparisons have to be made), and a number of fundamentally invalid possible matches are de-facto excluded. This leads to more efficient parallelization, and larger total amount of correct feature matches and less incorrect matches. In other words, the embodiments provide improved image-to-image registration and better 3D reconstruction of the recorded environment.

### BRIEF DESCRIPTION OF THE DRAWINGS

The accompanying drawings, which are incorporated herein and form part of the specification, illustrate various embodiments.

FIG. 1 illustrates a equirectangular image.

FIG. 2 illustrates a equirectangular image divided into four bands.

FIG. 3 illustrates two bands in a first image and two corresponding bands in a second image.

FIG. 4 illustrates triangulation.

FIG. 5 illustrates a property of the line of horizon.

FIG. 6 is a flowchart illustrating a process according to an embodiment.

FIG. 7 is a block diagram of an image processing apparatus according to an embodiment.

### DETAILED DESCRIPTION

This disclosure provides systems and methods that overcome at least some disadvantages noted above. Embodiments disclosed herein use the vertical alignment of 360-degree images to split each image into horizontal bands (strips). This reduces a range of correspondence search and automatically eliminates incorrect correspondences from consideration. For example, a pair of equirectangular images (Ea and Eb) are obtained using, for example, a 360-degree camera, e.g., camera placed on the tripod at different positions on the floor. The first image (Ea) is divided into horizontal sections and the second image (Eb) is also divided into horizontal sections, where each horizontal section within Ea has a corresponding horizontal section within Eb. That is, each horizontal section within Ea is paired with a horizontal section within Eb. Then, feature detection and matching is performed in the selected paired horizontal sections (do not perform search outside of paired sections). Then feature matches from all sections are joined into a list of image-pair matches and this list is used this as an input to a 3D reconstruction process and/or localization process.

### Example

This example is in the context of technician bringing 360-degree camera on a tripod to perform indoor scan. However, the embodiments are not limited to this example and can be also applied to other use cases, e.g., camera mounted on the roof of a vehicle. Preferably, the common requirement between use cases is to have the scanning device (e.g., 360° camera or other producing equirectangular images) placed upright and at roughly same offset from the ground level (e.g., floor, road, etc.).

In this example, at least two shots (Equirectangular images Ea and Eb) from a 360-camera taken at different positions in a scene (i.e., some real-world environment) are capture. When capturing Ea and image Eb, the camera is set upright (same as up-direction in Eb, which is towards the top of the equirectangular image) or, at least, the “up” direction is known from camera metadata. When capturing Ea and Eb, the camera is placed at the same height in both positions. The output of the example is a 3D point cloud and camera poses, generated from a set M(a,b) of pairwise matches between features in Ea and features in Eb.

A process according to this example includes the steps identified below

Step 1: Obtain a pair of equirectangular images Ea, Eb with a 360° camera.

This step 1 can be performed by: a) selecting two different positions, a and b, in the scene, b) fixing the camera on a base (e.g., tripod) such that the camera is upright and at a certain height, and c) capturing a first image (image Ia) from position a and capturing a second image (image Ib) from position b. If the captured images are not equirectangular images, but instead are dual-fisheye image type (Fa, Fb), then undistort and convert Fa, Fb to equirectangular image form Ea, Eb. (If captured images are equirectangular images, then Ia=Ea and Ib=Eb).

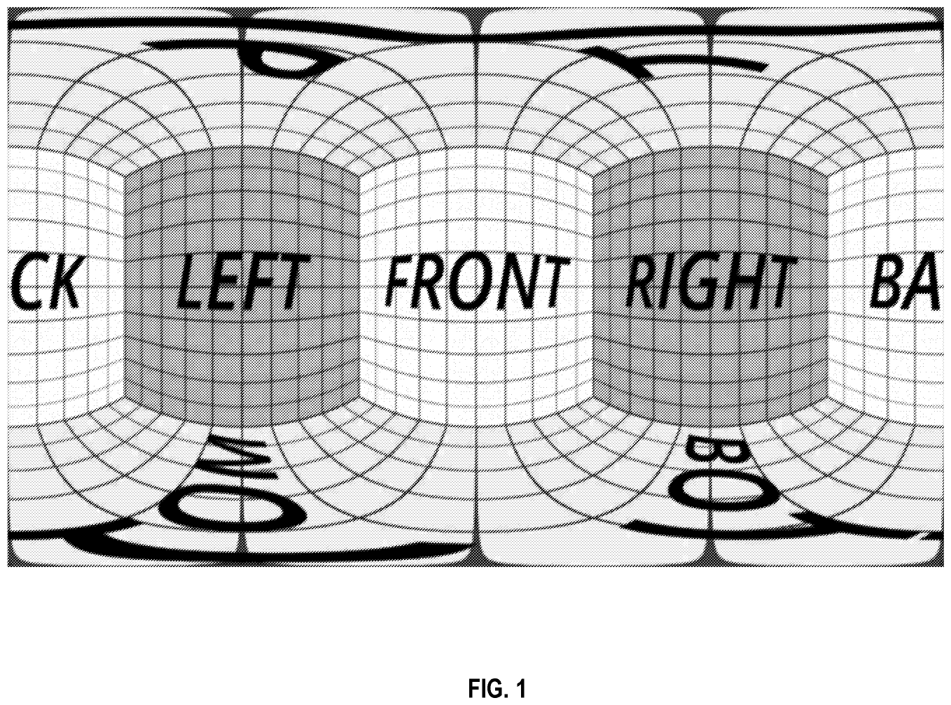

If the camera was not upright in positions a and b, then use, for example, metadata from the camera's inertial measurement unit (IMU) to convert (e.g., rotate) the non-upright captured images to upright equirectangular images Ea, Eb. In some embodiments, if the camera does not provide IMU data, and the environment is structured (i.e., mainly composed of planar surfaces), the Manhattan World assumption can be exploited to vertically align Ea, Eb as known in the art. The structure of the obtained in this step upright equirectangular images is visualized in FIG. 1, which shown the structure of an upright equirectangular image facing forwards, with an “up” direction towards the top of the image. The grid and text indicate the main directions of a 360-degree scene: front, left, right, back, top, bottom.

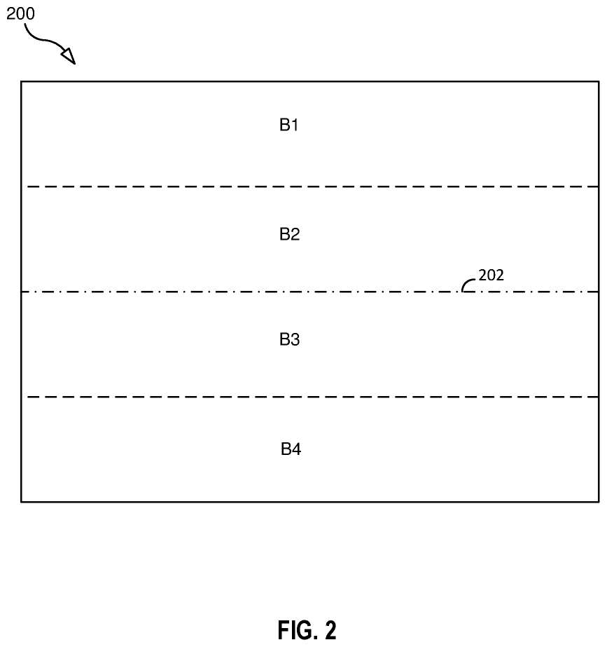

Step 2: Divide images Ea, Eb into sets of specific paired horizontal sections H(a,b,1), H(a,b,2), . . . , H(a,b,N). This step may begin with determining the “line of horizon” in Ea and Eb. Because Ea, Eb are upright images (from step 1), the line of horizon is the line bisecting each equirectangular image in half horizontally. This matches the 0° inclination (latitude) angle in the equirectangular image. Next, split Ea into a N horizontal regions (a.k.a., strips or bands). N has a preferred value of 4, but N could be an even number, between 2 and 8. The line of horizon serves as a boundary between at least two regions. The value of N depends on requirement for parallelization (complexity optimization) and key points density (if the visual scene contains textureless regions or is texture rich). FIG. 2 illustrates an example of dividing an image 200 (e.g., image Ea) into four bands (B1, B2, B3, and B4) and shows the line of horizon 202 for image 200.

Next, image Eb is split into the same number and distribution of bands as Ea, such that each band in Ea has a corresponding band in Eb. This creates a set H(a,b) of corresponding horizontal section pairs (each pair, H(a,b,N) having a band Ba and a band Bb).

Next, for each pair of corresponding bands Ba, Bb in set H(a,b). Expand the Bb band's top and bottom edge as follows. Expand by X % (e.g., X=10) unless the constraints below are met: i) if top or bottom edge of the band touches the line of horizon in Eb, do not change that edge, and ii) if the top or bottom edge of the band touches the top or bottom boundary of Eb, do not change that edge.

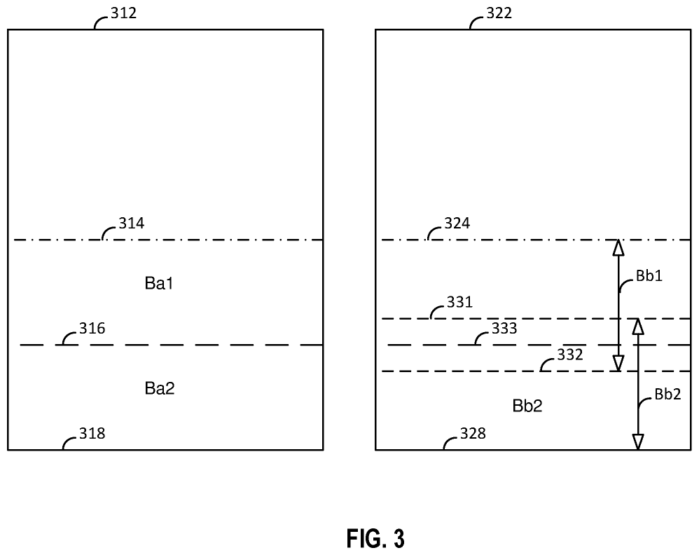

This is illustrated in FIG. 3. FIG. 3 shows a first image 312 (e.g., Ea) having a line of horizon 314, a bottom edge 318 (a.k.a., bottom boundary), and a dividing line 316 that divides the bottom half of image 312 into two bands: Ba1 and Ba2. FIG. 3 also shows a second image 322 (e.g., Eb) having a line of horizon 324, a bottom edge 328, and two dividing lines 331 and 332 that are used to define bands Bb1 and Bb2. Specifically, the top edge of band Bb1 is aligned with horizon line 324 and the bottom edge of band Bb1 is aligned with dividing line 332; the top edge of band Bb2 is aligned with dividing line 332 and the bottom edge of band Bb2 is aligned with the bottom edge 328 (a.k.a., bottom boundary). That is, the bottom boundary of band Bb1 is offset a distance from dividing line 333 (which corresponds to dividing line 316) towards bottom edge 328; and the top boundary of band Bb2 is offset a distance from dividing line 333 towards horizon line 324. Accordingly, while bands Bb1 and Bb2 are paired with bands Ba1 and Ba2, respectively, band Bb1 has a greater width than band Ba1 and band Bb2 has a greater width than band Ba2.

Step 3: In this third step, feature detection and matching is performed on the paired horizontal sections (set H(a,b) of multiple matched band pairs Ba and Bb), and all section matches are combined into a single list of feature matches M(a,b). This step may include the following sub-setps.

1) For each pair i of matched bands Ba and Bb (from a total of N pairs): a) detect image features within the band Ba (Ba being a horizontal sub-strip of the whole Ea) (the image features can be detected using any known feature detector, e.g. SIFT, ORB etc); this results in a list of features in Ba; b) detect image features within the corresponding band Bb (Bb being a horizontal sub-strip of the whole Eb) (e.g., Using the same feature detector as in the above step); this creates a list of features in Bb; and c) match the features in Ba to the features in Bb, e.g. using any known feature descriptor, such as SIFT with ratio test for matching. This creates a list of matches Mi for this specific band pair (H(a,b,i)).

2) Merge all the lists of matches Mi in a single list of matches M(a,b). That is, for each list of matches Mi the following steps are performed:
a) take a single match item from the list Mi (The match item connects a feature (position) in Ba to feature (position) in Bb);
b) calculate where the same feature (from Ba) is in Ea, and where the same feature (from Bb) is in Eb; for example, a feature is at position [xl,yl] in B(a,3), and the distance from top of the image to top edge of B(a,3) is d pixels. Then, the same feature's position [xg,yg] in Ea is calculated as: [xg, yg]=[xl, yl+d];
c) update the feature positions in the selected match item and add the updated match item to the list M_{a,b}; and
d) Repeat steps a,b,c for all match items in Mᵢ.
   This results in a single list of matches, M_{a,b}, where each match has a first feature in Eₐ and a second feature in E_{b}.

Step 4: Perform 3D reconstructing

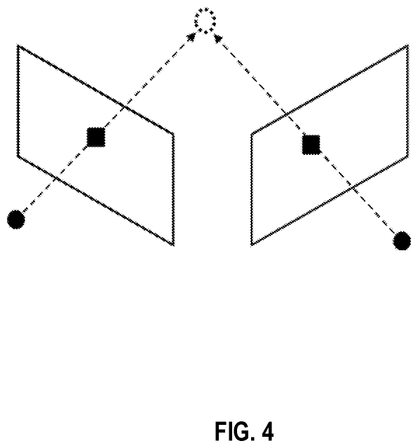

From the set of matched key points across images, perform triangulation (see FIG. 4) to establish position of points in the 3D space and camera poses. This step is achieved by applying SfM solution (e.g., COLMAP). As shown in FIG. 4, the 3D geometry of the scene is reconstructed by stitching different shots and performing triangulation. Black circles in the figure are the camera positions, black squares are a key point common for both images (e.g., corner of the same object in the physical scene), the dashed circle is the 3D point of the sparse point cloud obtained by triangulation

Evidence of how the proposed solution improves on the accuracy of 3D reconstruction is presented in the results section below.

### Avoidance of the Line of Horizon

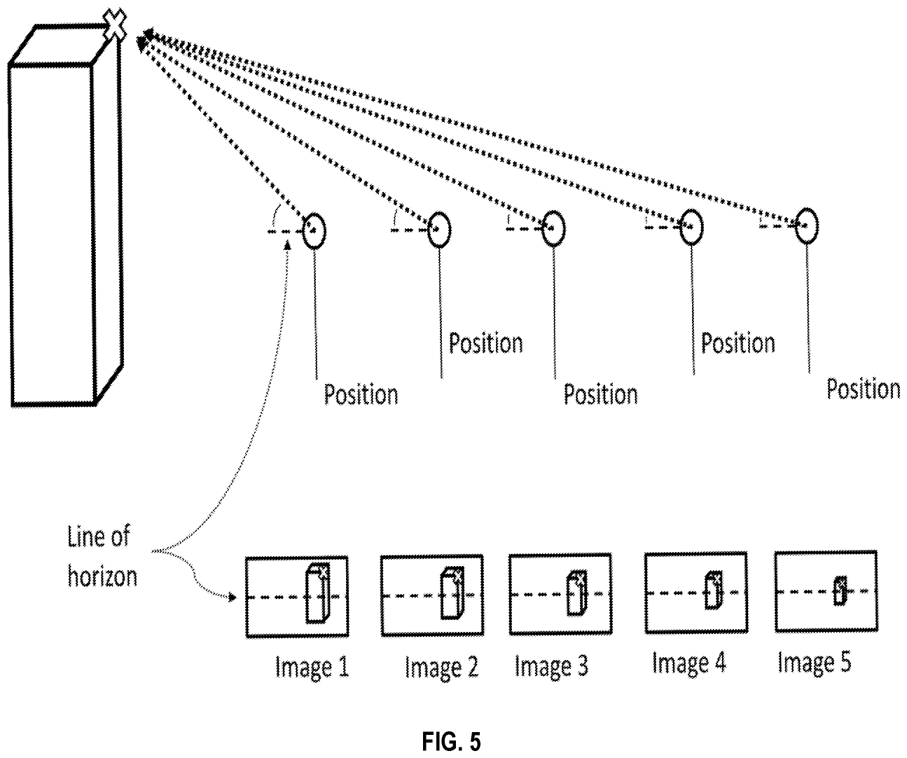

The line of horizon is a constraint unique to equirectangular images, and functions because the cameras are placed at the same height. The Line of horizon describes the 0-degree angle of the real world; as cameras are moved closer and farther from real world objects, the apparent angle of those objects will be closer or farther from the 0-degree angle but will never cross it (See FIG. 5). That's why the line of horizon is an effective constraint on the feature-matching search. For example: if a camera is recording one object (one keypoint) from a handful of positions at the same height, then that key point may be at some angle above the line of horizon at those positions. FIG. 5 shows this scenario, with one keypoint (X) and camera at 5 positions of the same height. The exact angle between X and line of horizon will get smaller as the distance increases, but the angle will never reach 0.

FIG. 5 shows, as you move to farther and farther positions, the angle value does get smaller, but never reaches nor crosses zero. This exact same principle applies if two (or more) cameras are seeing the object from two positions at the same time. This is useful because: if the cameras are at the same height, then if one camera sees the object above the line of horizon, the other camera must also see the object above the line of horizon, and we must search for matches only in the area above the line of horizon. If the matching process tries to match a point above line of horizon in one image, and a point below line of horizon in another image (so crossing the line of horizon), we know that that is a wrong match and should be discarded/ignored.

### Results

Comparison of the method disclosed above (feature matching using paired horizontal bands of equirectangular image) vs. feature matching using entire equirectangular image at once, is shown in table 1 below. The colum labled “Number of reconstructed 3D points” (higher number is better) indicates how many 3D points were reconstructed as a result of successful matches of keypoints across images. Sample results from feature matching on an equirectangular image pair. The first row represents the prior art, conventionally used technique for key point matching. The optimal configuration is presented in row 4 (Number of bands=4, band padding=10%). The optimal configuration provides largest number rec. 3D points.

TABLE 1

| | Bb band | |
|---|---|---|
| | padding | Number of reconstructed 3D |
| Number of Bands | (%) | points |
| N=1 Search in the whole image | — | 99 |
| (no banding). This is the | | |
| conventional approach | | |
| N=2 | 0% | 76 |
| | 3% | 121 |
| | 10% | 121 |
| N=3 (this ignores the line-of- | 0% | 93 |
| horizon constraint) | 3% | 118 |
| | 10% | 114 |
| N=4 | 0% | 110 |
| | 3% | 125 |
| | 10% | 135 |
| N=5 (this ignores the line-of- | 0% | 76 |
| horizon constraint) | 3% | 83 |
| | 10% | 98 |

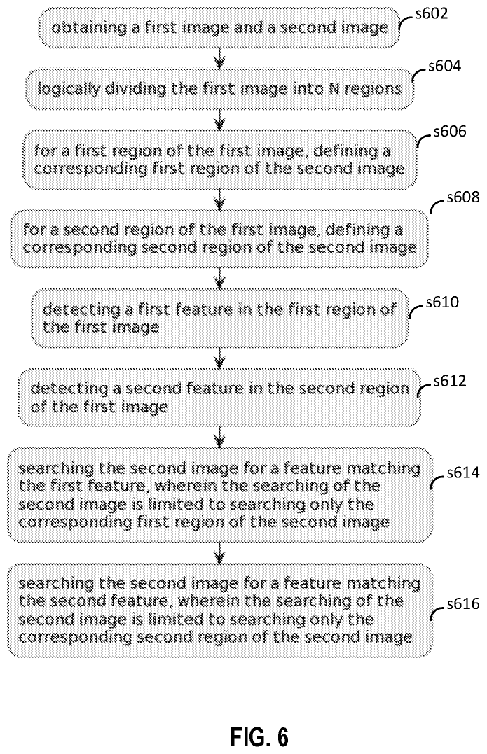

FIG. 6 is a flow chart illustrating a process 600, according to an embodiment, for processing images. Process 600 may begin in step s602.

Step s602 comprises obtaining a first image and a second image

Step s604 comprises logically dividing the first image into N regions, where N≥2 such that the set of N regions comprises a first region of the first image and a second region of the first image, wherein the first region of the first image does not include the entire first image, the second region of the first image does not include the entire first image, and the first region of the first image and the second region of the first image do not overlap.

Step s606 comprises, for the first region of the first image, defining a corresponding first region of the second image, wherein the corresponding first region of the second image does not include the entire second image.

Step s608 comprises, for the second region of the first image, defining a corresponding second region of the second image, wherein the corresponding second region of the second image does not include the entire second image.

Step s610 comprises detecting a first feature in the first region of the first image.

Step s612 comprises detecting a second feature in the second region of the first image.

Step s614 comprises searching the second image for a feature matching the first feature detected in the first region of the first image, wherein the searching of the second image for a feature matching the first feature detected in the first region of the first image is limited to searching only the corresponding first region of the second image for a feature matching the first feature.

Step s616 comprises searching the second image for a feature matching the second feature detected in the second region of the first image, wherein the searching of the second image for a feature matching the second feature detected in the second region of the first image is limited to searching only the corresponding second region of the second image for a feature matching the second feature.

In some embodiments, the first image is rectangular and has a length of L and a width of W, the first region of the first image is rectangular and has a length equal to L and a width of W1 where W1≤W/2, and the second region of the first image is rectangular and has a length equal to L and a width of W1.

In some embodiments, the second image is rectangular and has a length of L and a width of W, the corresponding first region of the second image is rectangular and has a length equal to L and a width of W2 where W2>W1, and the corresponding second region of the second image is rectangular and has a length equal to L and a width of W3 where W3>W1.

In some embodiments, the first image has a bottom boundary, a top boundary, and a middle line that bisects the first image and is equal in distance from the top and bottom boundaries (e.g., line of horizon), the first region of the first image has a bottom boundary aligned with the bottom boundary of the first image and a top boundary that is below and parallel with the middle line, the second region of the first image has a bottom boundary aligned with the top boundary of the first region of the image, and the second region of the first image has a top boundary that aligns with the middle line of the first image or is below and parallel with the middle line of the first image.

In some embodiments, the second image has a bottom boundary, a top boundary, and a middle line that bisects the second image and is equal in distance from the top and bottom boundaries of the second image, the corresponding first region of the second image has a bottom boundary aligned with the bottom boundary of the second image and a top boundary that is below and parallel with the middle line of the second image, the corresponding second region of the second image has a bottom boundary that is below the top boundary of the corresponding first region of the second image, and the corresponding second region of the second image has a top boundary that is aligned with the middle line of the second image or is below and parallel with the middle line of the second image.

In some embodiments, the top boundary of the second region of the first image aligns with the middle line of the first image, and the top boundary of the corresponding second region of the second image aligns with the middle line of the second image.

In some embodiments, the set of N regions further comprises a third region of the first image and a fourth region of the first image, W1=W/4, the third region of the first image is rectangular and has a length equal to L and a width of W1, the fourth region of the first image is rectangular and has a length equal to L and a width of W1, the third region of the first image has a bottom boundary aligned with middle line of the first image and a top boundary that is below the top boundary of the first image, the fourth region of the first image has a bottom boundary aligned with the top boundary of the third region of the first image and a top boundary that aligns with the top boundary of the first image, the method further comprises, for the third region of the first image, defining a corresponding third region of the second image, the method further comprises, for the fourth region of the first image, defining a corresponding fourth region of the second image, the corresponding third region of the second image has a bottom boundary aligned with the middle line of the second image and a top boundary that is below the top boundary of the second image, and the corresponding fourth region of the second image has a bottom boundary below the top boundary of the corresponding third region of the second image and a top boundary that is aligned with the top boundary of the second image.

In some embodiments, determining that the corresponding first region of the second image has a feature matching the first feature detected in the first region of the first image, wherein the first feature has a position within the first image, the feature matching the first feature has a position within the second image, and the method further comprises using the position of the first feature and the position of the feature matching the first feature to determine a first point within a three-dimensional, 3D, space.

In some embodiments the method also includes determining that the corresponding second region of the second image has a feature matching the second feature detected in the second region of the first image, wherein the second feature has a position within the first image, the feature matching the second feature has a position within the second image, and the method further comprises using the position of the second feature and the position of the feature matching the second feature to determine a second point within the 3D space.

In some embodiments, the first image is a first equirectangular image captured by a 360-degree camera in an upright orientation or derived from a first captured image, and the second image is a second equirectangular image captured by a 360-degree camera in an upright orientation or derived from a second captured image.

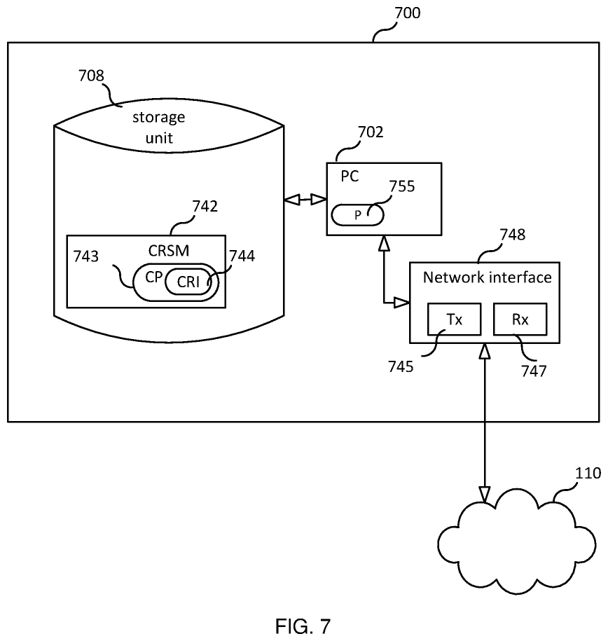

FIG. 7 is a block diagram of image processing apparatus 700, according to some embodiments. As shown in FIG. 7, image processing apparatus 700 may comprise: processing circuitry (PC) 702, which may include one or more processors (P) 755 (e.g., one or more general purpose microprocessors and/or one or more other processors, such as an application specific integrated circuit (ASIC), field-programmable gate arrays (FPGAs), and the like), which processors may be co-located in a single housing or in a single data center or may be geographically distributed (i.e., image processing apparatus 700 may be a distributed computing apparatus); at least one network interface 748 (e.g., a physical interface or air interface) comprising a transmitter (Tx) 745 and a receiver (Rx) 747 for enabling image processing apparatus 700 to transmit data to and receive data from other nodes connected to a network 110 (e.g., an Internet Protocol (IP) network) to which network interface 748 is connected (physically or wirelessly) (e.g., network interface 748 may be coupled to an antenna arrangement comprising one or more antennas for enabling image processing apparatus 700 to wirelessly transmit/receive data); and a storage unit (a.k.a., “data storage system”) 708, which may include one or more non-volatile storage devices and/or one or more volatile storage devices. In embodiments where PC 702 includes a programmable processor, a computer readable storage medium (CRSM) 742 may be provided. CRSM 742 may store a computer program (CP) 743 comprising computer readable instructions (CRI) 744. CRSM 742 may be a non-transitory computer readable medium, such as, magnetic media (e.g., a hard disk), optical media, memory devices (e.g., random access memory, flash memory), and the like. In some embodiments, the CRI 744 of computer program 743 is configured such that when executed by PC 702, the CRI causes image processing apparatus 700 to perform steps described herein (e.g., steps described herein with reference to the flow charts). In other embodiments, image processing apparatus 700 may be configured to perform steps described herein without the need for code. That is, for example, PC 702 may consist merely of one or more ASICs. Hence, the features of the embodiments described herein may be implemented in hardware and/or software.

While various embodiments are described herein, it should be understood that they have been presented by way of example only, and not limitation. Thus, the breadth and scope of this disclosure should not be limited by any of the above-described exemplary embodiments. Moreover, any combination of the above-described elements in all possible variations thereof is encompassed by the disclosure unless otherwise indicated herein or otherwise clearly contradicted by context. As used herein “a” means “at least one” or “one or more.”

Additionally, while the processes described above and illustrated in the drawings are shown as a sequence of steps, this was done solely for the sake of illustration. Accordingly, it is contemplated that some steps may be added, some steps may be omitted, the order of the steps may be re-arranged, and some steps may be performed in parallel.

1. A method for processing images, the method comprising:
obtaining a first image;
obtaining a second image;
logically dividing the first image into N regions, where N≥2 such that the set of N regions comprises a first region of the first image and a second region of the first image, wherein the first region of the first image does not include the entire first image, the second region of the first image does not include the entire first image, and the first region of the first image and the second region of the first image do not overlap;
for the first region of the first image, defining a corresponding first region of the second image, wherein the corresponding first region of the second image does not include the entire second image;
for the second region of the first image, defining a corresponding second region of the second image, wherein the corresponding second region of the second image does not include the entire second image;
detecting a first feature in the first region of the first image;
detecting a second feature in the second region of the first image;
searching the second image for a feature matching the first feature detected in the first region of the first image, wherein the searching of the second image for a feature matching the first feature detected in the first region of the first image is limited to searching only the corresponding first region of the second image for a feature matching the first feature; and
searching the second image for a feature matching the second feature detected in the second region of the first image, wherein the searching of the second image for a feature matching the second feature detected in the second region of the first image is limited to searching only the corresponding second region of the second image for a feature matching the second feature.

2. The method of claim 1, wherein
the first image is rectangular and has a length of L and a width of W,
the first region of the first image is rectangular and has a length equal to L and a width of W1 where W1≤W/2, and
the second region of the first image is rectangular and has a length equal to L and a width of W1.

3. The method of claim 2, wherein
the second image is rectangular and has a length of L and a width of W,
the corresponding first region of the second image is rectangular and has a length equal to L and a width of W2 where W2>W1, and
the corresponding second region of the second image is rectangular and has a length equal to L and a width of W3 where W3>W1.

4. The method of claim 3, wherein
the first image has a bottom boundary, a top boundary, and a middle line that bisects the first image and is equal in distance from the top and bottom boundaries,
the first region of the first image has a bottom boundary aligned with the bottom boundary of the first image and a top boundary that is below and parallel with the middle line,
the second region of the first image has a bottom boundary aligned with the top boundary of the first region of the image, and
the second region of the first image has a top boundary that aligns with the middle line of the first image or is below and parallel with the middle line of the first image.

5. The method of claim 4, wherein
the second image has a bottom boundary, a top boundary, and a middle line that bisects the second image and is equal in distance from the top and bottom boundaries of the second image,
the corresponding first region of the second image has a bottom boundary aligned with the bottom boundary of the second image and a top boundary that is below and parallel with the middle line of the second image,
the corresponding second region of the second image has a bottom boundary that is below the top boundary of the corresponding first region of the second image, and
the corresponding second region of the second image has a top boundary that is aligned with the middle line of the second image or is below and parallel with the middle line of the second image.

6. The method of claim 5, wherein
the top boundary of the second region of the first image aligns with the middle line of the first image, and
the top boundary of the corresponding second region of the second image aligns with the middle line of the second image.

7. The method of claim 6, wherein
the set of N regions further comprises a third region of the first image and a fourth region of the first image,
$$W 1 = W / 4 ,$$
the third region of the first image is rectangular and has a length equal to L and a width of W1,
the fourth region of the first image is rectangular and has a length equal to L and a width of W1,
the third region of the first image has a bottom boundary aligned with middle line of the first image and a top boundary that is below the top boundary of the first image,
the fourth region of the first image has a bottom boundary aligned with the top boundary of the third region of the first image and a top boundary that aligns with the top boundary of the first image,
the method further comprises, for the third region of the first image, defining a corresponding third region of the second image,
the method further comprises, for the fourth region of the first image, defining a corresponding fourth region of the second image,
the corresponding third region of the second image has a bottom boundary aligned with the middle line of the second image and a top boundary that is below the top boundary of the second image, and
the corresponding fourth region of the second image has a bottom boundary below the top boundary of the corresponding third region of the second image and a top boundary that is aligned with the top boundary of the second image.

8. The method of claim 1, further comprising
determining that the corresponding first region of the second image has a feature matching the first feature detected in the first region of the first image, wherein
the first feature has a position within the first image,
the feature matching the first feature has a position within the second image, and
the method further comprises using the position of the first feature and the position of the feature matching the first feature to determine a first point within a three-dimensional, 3D, space.

9. The method of claim 8, further comprising
determining that the corresponding second region of the second image has a feature matching the second feature detected in the second region of the first image, wherein
the second feature has a position within the first image,
the feature matching the second feature has a position within the second image, and
the method further comprises using the position of the second feature and the position of the feature matching the second feature to determine a second point within the 3D space.

10. The method of claim 1, wherein
the first image is a first equirectangular image captured by a 360-degree camera or derived from a first captured image, and
the second image is a second equirectangular image captured by a 360-degree camera or derived from a second captured image.

11. An image processing apparatus for processing images, the image processing apparatus being configured to perform a method comprising:
obtaining a first image;
obtaining a second image;
logically dividing the first image into N regions, where N≥2 such that the set of N regions comprises a first region of the first image and a second region of the first image, wherein the first region of the first image does not include the entire first image, the second region of the first image does not include the entire first image, and the first region of the first image and the second region of the first image do not overlap;
for the first region of the first image, defining a corresponding first region of the second image, wherein the corresponding first region of the second image does not include the entire second image;
for the second region of the first image, defining a corresponding second region of the second image, wherein the corresponding second region of the second image does not include the entire second image;
detecting a first feature in the first region of the first image;
detecting a second feature in the second region of the first image;
searching the second image for a feature matching the first feature detected in the first region of the first image, wherein the searching of the second image for a feature matching the first feature detected in the first region of the first image is limited to searching only the corresponding first region of the second image for a feature matching the first feature; and
searching the second image for a feature matching the second feature detected in the second region of the first image, wherein the searching of the second image for a feature matching the second feature detected in the second region of the first image is limited to searching only the corresponding second region of the second image for a feature matching the second feature.

12. The image processing apparatus of claim 11, wherein
the first image is rectangular and has a length of L and a width of W,
the first region of the first image is rectangular and has a length equal to L and a width of W1 where W1≤W/2, and
the second region of the first image is rectangular and has a length equal to L and a width of W1.

13. The image processing apparatus of claim 12, wherein
the second image is rectangular and has a length of L and a width of W,
the corresponding first region of the second image is rectangular and has a length equal to L and a width of W2 where W2>W1, and
the corresponding second region of the second image is rectangular and has a length equal to L and a width of W3 where W3>W1.

14. The image processing apparatus of claim 13, wherein
the first image has a bottom boundary, a top boundary, and a middle line that bisects the first image and is equal in distance from the top and bottom boundaries,
the first region of the first image has a bottom boundary aligned with the bottom boundary of the first image and a top boundary that is below and parallel with the middle line,
the second region of the first image has a bottom boundary aligned with the top boundary of the first region of the image, and
the second region of the first image has a top boundary that aligns with the middle line of the first image or is below and parallel with the middle line of the first image.

15. The image processing apparatus of claim 14, wherein
the second image has a bottom boundary, a top boundary, and a middle line that bisects the second image and is equal in distance from the top and bottom boundaries of the second image,
the corresponding first region of the second image has a bottom boundary aligned with the bottom boundary of the second image and a top boundary that is below and parallel with the middle line of the second image,
the corresponding second region of the second image has a bottom boundary that is below the top boundary of the corresponding first region of the second image, and
the corresponding second region of the second image has a top boundary that is aligned with the middle line of the second image or is below and parallel with the middle line of the second image.

16. The image processing apparatus of claim 15, wherein
the top boundary of the second region of the first image aligns with the middle line of the first image, and
the top boundary of the corresponding second region of the second image aligns with the middle line of the second image.

17. The image processing apparatus of claim 16, wherein
the set of N regions further comprises a third region of the first image and a fourth region of the first image,
$$W 1 = W / 4 ,$$
the third region of the first image is rectangular and has a length equal to L and a width of W1,
the fourth region of the first image is rectangular and has a length equal to L and a width of W1,
the third region of the first image has a bottom boundary aligned with middle line of the first image and a top boundary that is below the top boundary of the first image,
the fourth region of the first image has a bottom boundary aligned with the top boundary of the third region of the first image and a top boundary that aligns with the top boundary of the first image,
the method further comprises, for the third region of the first image, defining a corresponding third region of the second image,
the method further comprises, for the fourth region of the first image, defining a corresponding fourth region of the second image,
the corresponding third region of the second image has a bottom boundary aligned with the middle line of the second image and a top boundary that is below the top boundary of the second image, and
the corresponding fourth region of the second image has a bottom boundary below the top boundary of the corresponding third region of the second image and a top boundary that is aligned with the top boundary of the second image.

18. The image processing apparatus claim 11, further comprising
determining that the corresponding first region of the second image has a feature matching the first feature detected in the first region of the first image; and
determining that the corresponding second region of the second image has a feature matching the second feature detected in the second region of the first image, wherein
the first feature has a position within the first image,
the feature matching the first feature has a position within the second image,
the method further comprises using the position of the first feature and the position of the feature matching the first feature to determine a first point within a three-dimensional, (3D) space,
the second feature has a position within the first image,
the feature matching the second feature has a position within the second image, and
the method further comprises using the position of the second feature and the position of the feature matching the second feature to determine a second point within the 3D space.

19. (canceled)

20. The image processing apparatus of claim 11, wherein
the first image is a first equirectangular image captured by a 360-degree camera or derived from a first captured image, and
the second image is a second equirectangular image captured by a 360-degree camera or derived from a second captured image.

21. A non-transitory computer readable storage medium storing a computer program comprising instructions which when executed by processing circuitry of an image processing apparatus causes the image processing apparatus to perform the method of claim 1.

22. (canceled)
